(19) United States
(12) Patent Application Publication
(10) Pub. No.: US 2019/0186388 A1
(43) Pub. Date: Jun. 20, 2019

(54) Exhaust Gas Recirculation Blower And Internal Combustion Engine

(71) Applicant: MAN ENERGY SOLUTIONS SE, Augsburg (DE)

(72) Inventors: Klaus BARTHOLOMÄ, Friedberg (DE); Ondrej TOMEK, Námest nad Oslavou (DE); Jirí KLÍMA, Námest nad Oslavou (DE)

(21) Appl. No.: 16/225,780

(22) Filed: Dec. 19, 2018

(30) Foreign Application Priority Data
Dec. 20, 2017 (DE) 102017130625.0

(51) Int. Cl. F02D 21/08; F02M 26/04; F02M 26/09; F02M 26/41

(52) U.S. Cl. CPC F02D 21/08; F02M 26/04; F02D 41/0007; F02M 26/41; F02M 26/09

(57) ABSTRACT

An exhaust gas recirculation blower of an internal combustion engine, with a stator and a rotor. Assemblies of the stator and the rotor, which serve for conducting exhaust gas, consist of a material that is corrosion-resistant and erosion-resistant when exposed to an acidic atmosphere.

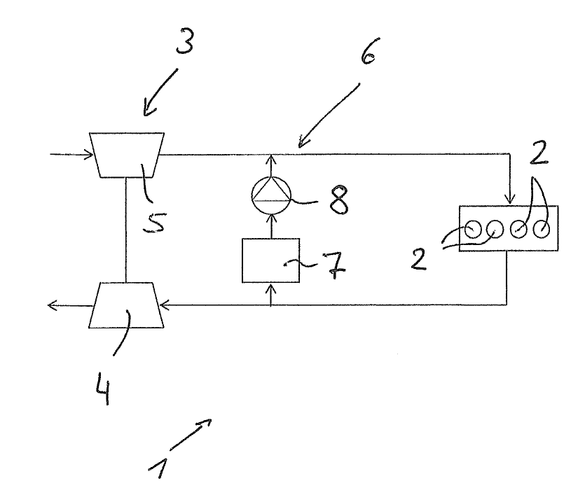

### BACKGROUND OF THE INVENTION

### 1. Field of the Invention

The invention relates to an exhaust gas recirculation blower and to an internal combustion engine.

### 2. Description of the Related Art

Internal combustion engines with exhaust gas recirculation are familiar to the person skilled in the art. In such internal combustion engines it is known to extract exhaust gas, which leaves the internal combustion engine, from an exhaust gas branch of the internal combustion engine and to conduct said exhaust gas via a so-called exhaust gas recirculation blower of the exhaust gas recirculation, which is also referred to as an EGR blower, in the direction of a charge air tract of the internal combustion engine and then mix the exhaust gas with the charge air to be fed to the cylinders of the internal combustion engine.

Exhaust gas recirculation blowers or EGR blowers are typically embodied as turbo compressors, which compress the exhaust gas to a defined pressure. An exhaust gas recirculation blower of an exhaust gas recirculation of an internal combustion engine comprises at least one compressor stage, wherein the or each compressor stage, namely a rotor of the same, can be driven via a shaft that is mounted in a housing of the exhaust gas recirculation blower. Here, an electric motor typically assumes the driving of the shaft and via the shaft, the driving of the rotor of the or each compressor stage of the exhaust gas recirculation blower.

Exhaust gas recirculation blowers known from practice are subject to wear, as a result of which it is required to subject the exhaust gas recirculation blower to a repair or even replacement at defined intervals. This is disadvantageous. There is a need for an exhaust gas recirculation blower that is subject to less wear.

### SUMMARY OF THE INVENTION

One aspect of the present invention is based on the object of creating a new type of exhaust gas recirculation blower and an internal combustion engine with such an exhaust gas recirculation blower.

According to one aspect the invention, such assemblies of the stator and of the rotor, which serve for conducting exhaust gas, consist of a material that is corrosion-resistant and erosion-resistant when exposed to an acidic atmosphere, preferentially metal material. In particular when the assemblies of stator and rotor serving for conducting the exhaust gas consist of such a material, the exhaust gas recirculation blower is subject to less wear. As a result, the invention is based on the realisation that the exhaust gas of internal combustion engines operated with heavy fuel oil and gas, such as for example of large internal combustion engines employed on a ship, has a tendency towards condensation and acid-formation during the conduction via the exhaust gas recirculation blower, in particular because of a high sulphur content in the exhaust gas. In particular when the assemblies of the stator and of the rotor of the exhaust gas recirculation blower serving for the exhaust gas conduction consists of a material that is corrosion-resistant and erosion-resistant when exposed to an acidic atmosphere, the lifespan of the exhaust gas recirculation blower can be increased, since the same is then less susceptible to wear.

According to an advantageous further development, such assemblies of the stator, which serve for the conduction of exhaust gas, consist of an austenitic steel or of a duplex steel. Such assemblies of the rotor, which serve for the conduction of exhaust gas, consist, according to a first version, of an austenitic steel or a duplex steel or according to a second version, of a titanium alloy. The utilisation of austenitic steel or duplex steel for the assemblies of the stator serving for the conduction of the exhaust gas is preferred. Such a steel can also be utilised for assemblies of the rotor serving for the conduction of the exhaust gas, but these assemblies of the rotor preferentially consist of a titanium alloy.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The FIGURE a block diagram of an internal combustion engine with exhaust gas recirculation and an exhaust gas recirculation blower.

### DETAILED DESCRIPTION OF THE PRESENTLY PREFERRED EMBODIMENTS

The invention relates to an exhaust gas recirculation blower of an exhaust gas recirculation of an internal combustion engine.

Such an exhaust gas recirculation blower serves for conveying and compressing exhaust gas, which is extracted from an exhaust gas tract of an internal combustion engine and conveyed in the direction of a charge air tract of the internal combustion engine with the help of the exhaust gas recirculation blower. The invention, furthermore, relates to an internal combustion engine with exhaust gas recirculation.

The FIGURE shows a block diagram of an internal combustion engine 1 with multiple cylinders 2. During the operation of the internal combustion engine 1, exhaust gas is created, which leaves the cylinders 2 of the internal combustion engine 1, and is conducted in the direction of a turbine 4 of an exhaust gas turbocharger 3 of the internal combustion engine 1. The exhaust gas leaving the cylinders 2 of the internal combustion engine 1, which is conducted via the turbine 4 of the exhaust gas turbocharger 3, is expanded in the turbine 4, wherein energy extracted in the process is utilised in order to compress charge air to be fed to the cylinders 2 of the internal combustion engine 1 in the compressor 5 of the exhaust gas turbocharger 3.

The internal combustion engine 1 of the FIGURE comprises an exhaust gas recirculation 6. The exhaust gas recirculation 6 comprises an exhaust gas recirculation cooler 7 and an exhaust gas recirculation blower 8. The exhaust gas recirculation cooler 7 serves for cooling exhaust gas which in the FIGURE is extracted upstream of the turbine 4 at high pressure from an exhaust gas tract leading to the turbine 4. The exhaust gas recirculation blower 8 conveys the exhaust gas conducted via the exhaust gas recirculation cooler 7 in the direction of the charge air tract of the internal combustion engine in order to mix this exhaust gas of the exhaust gas recirculation with the compressed charge air upstream of the compressor 5.

The internal combustion engine 1 is in particular an internal combustion engine in which heavy fuel oil or gas is conducted, for example an internal combustion engine of a ship. Heavy fuel oil and gas can contain sulphur which when conducted via the exhaust gas recirculation blower 8 can condense subject to forming acid.

According to one aspect the present invention, it is proposed that such assemblies of a stator and of a rotor of the exhaust gas recirculation blower 8, which serve for conducting the exhaust gas, consist of a material that is corrosion-resistant and erosion-resistant when exposed to an acidic atmosphere, in particular a corresponding metal material.

The assemblies of the stator which serve for conducting exhaust gas are in particular an intake socket, a compressor housing, and a diffuser, wherein these assemblies altogether define an exhaust gas flow passage at least in sections.

The assemblies of the rotor, which serve for conducting the exhaust gas, are in particular a compressor impeller, and/or impeller blades, and/or a shaft.

The intake socket of the stator defines an exhaust gas flow passage upstream of the compressor impeller, whereas the diffuser defines the exhaust gas flow passage downstream of the compressor impeller. The compressor housing defines an exhaust gas flow passage in particular between the intake socket and the diffuser adjacent to the impeller blades of the compressor impeller.

As already explained, the assemblies of the stator and of the rotor serving for conducting exhaust gas consist of a material that is corrosion-resistant and erosion-resistant when exposed to an acidic atmosphere, preferentially of a corresponding metal material. Here, the assemblies of the rotor, which serve for conducting exhaust gas, preferentially consist of an austenitic steel or of a duplex steel. The assemblies of the rotor, which serve for conducting exhaust gas, can also consist of an austenitic steel or of a duplex steel, but the assemblies of the rotor, which serve for conducting exhaust gas, preferentially consist of a titanium alloy.

As already explained, the exhaust gas recirculation blower 8 according to the invention is preferably employed on an internal combustion engine that is operated with heavy fuel oil or gas, such as a large internal combustion engine, in particular an internal combustion engine of a ship.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An exhaust gas recirculation blower of an internal combustion engine, comprising:
a stator; and
a rotor;
wherein:
assemblies of the stator and the rotor, which conduct exhaust gas, comprise a material that is corrosion-resistant and erosion-resistant when exposed to an acidic atmosphere.

2. The exhaust gas recirculation blower according to claim 1, wherein the material is a metal material that is corrosion-resistant and erosion-resistant when exposed to the acidic atmosphere.

3. The exhaust gas recirculation blower according to claim 2, wherein the assemblies of the stator comprise one or more of:
an intake socket,
a compressor housing, and
a diffuser.

4. The exhaust gas recirculation blower according to claim 2, wherein the metal material comprises an austenitic steel or a duplex steel.

5. The exhaust gas recirculation blower according to claim 3, wherein the metal material comprises an austenitic steel or a duplex steel.

6. The exhaust gas recirculation blower according to claim 2, wherein the assemblies of the rotor comprise one or more of:
a compressor impeller,
an impeller blades, and
a compressor shaft.

7. The exhaust gas recirculation blower according to claim 6, wherein the metal material comprises an austenitic steel or a duplex steel.

8. The exhaust gas recirculation blower according to claim 1, wherein the assemblies of the rotor, which serve for conducting exhaust gas, comprise a titanium alloy.

9. An internal combustion engine, comprising:
multiple cylinders; and
an exhaust gas turbocharger comprising:
a turbine configured to expand exhaust gas leaving the multiple cylinders; and
a compressor configured to use energy extracted by the turbine to compress charge air fed to the multiple cylinders;
an exhaust gas recirculation comprising:
an exhaust gas recirculation cooler; and
an exhaust gas recirculation blower, comprising:
a stator; and
a rotor;
wherein:
assemblies of the stator and the rotor, which conduct exhaust gas, comprise a material that is corrosion-resistant and erosion-resistant when exposed to an acidic atmosphere.

10. The internal combustion engine according to claim 9, wherein the internal combustion engine is a large internal combustion engine operated with one of heavy fuel oil or gas.
